(19) United States
(12) Patent Application Publication
(10) Pub. No.: US 2009/0051523 A1
(43) Pub. Date: Feb. 26, 2009

(54) LED SEQUENTIAL LIGHTING SYSTEM FOR VEHICLES AND METHOD OF USE

(76) Inventor: Mark Perkins, Las Vegas, NV (US)

Correspondence Address: GREENBERG TRAURIG, 3773 HOWARD HUGHES PARKWAY, SUITE 500 NORTH, LAS VEGAS, NV, 89169, US

(21) Appl. No.: 12/196,141

(22) Filed: Aug. 21, 2008

Related U.S. Application Data
(63) Continuation-in-part of application No. 11/844,988, filed on Aug. 24, 2007.

(51) Int. Cl. B60Q 1/34

(52) U.S. Cl. 340/478

(57) ABSTRACT

Described is a sequential lighting system that is controlled by a control circuit. The sequential lighting system includes a series of LEDs, a housing having a plurality of compartments or devices with each compartment configured to contain one or more of said LEDs and a control circuit operable to illuminate said LEDs in a pre-determined sequence to signify a current state of said vehicle or an intended maneuver of said vehicle. Such a sequential lighting system provides a more noticeable and visible image than conventional lighting systems which comprise an on-off illumination of one or more LEDs forming the turn signal. An integrated light sensor also provides means for controlling the brightness of the LEDs when activated according to external lighting conditions. In an after market version, control means permits a flasher rate to be automatically determined upon installation of the lighting system.

### CROSS-REFERENCE

This application is a continuation-in-part of application Ser. No. 11/844,988 filed Aug. 24, 2007.

### FIELD OF THE INVENTION

The embodiments of the present invention relate to a light emitting diode (“LED”) lighting systems for vehicles (e.g., motorcycles) wherein said LED lighting systems utilize a sequential operation.

### BACKGROUND

Street legal automobiles, motorcycles and other vehicles have lighting systems comprising brake lights, turn signals and/or running lights. It is these lights that permit vehicle operators to notify other drivers of their intentions with respect to the vehicle. These lights are therefore critically important in preventing accidents and corresponding injuries. While current lighting systems are suitable for their purpose, they are not without drawbacks, including lack of visibility.

Despite the use of lighting systems, the incidence of collisions remains relatively high when motorcycles are involved. For example, when motorcycles are stopped, especially when behind other traffic, they are less visible than larger vehicles. Since the tail light is constantly illuminated on most motorcycles, the illumination of the brake light may be hard to recognize when the motorcycle is near other vehicles with bright brake lights. Similarly, the illumination of turn signal lights, because of the narrow width of the motorcycle, does not always adequately alert the following motorists of the intent of the motorcycle operator.

On the other hand, there are advantages to integrating the lighting fixtures of motorcycles so that multiple light fixtures are not needed to provide tail light, brake light, running light, and turn signal functions. This is especially desired for the smaller more nimble sport motorcycles. But while a single integrated rear light fixture can be used that provides the various functions, the turn signal aspect of such integrated fixtures makes it hard to discern the intended direction of the turn to a following motorist, because flashing incandescent lights or LED arrays often do not provide adequate spatial separation in such integrated housings to indicate clearly the direction of the intended turn. This is especially true in driving conditions with poor visibility, or at relatively longer distances.

Various alternative rear light systems have been developed in an effort to solve these problems. However, such alternative light systems have various disadvantages which compromise rather than improve safety. For example, many alternative systems utilize unreliable mechanical components such as incandescent bulbs, mechanical relays having physical contacts, cams, levers, and other mechanical parts which can cause the entire vehicle brake light system to fail. Thus, while such conventional flashing light systems provide an increased measure of safety when working properly, any improvement is clearly overshadowed by the possibility of a dangerous total light failure.

In addition, many alternative light systems may require extensive modification of the stock equipment for proper installation and function. Further, conventional flashing brake light systems impose an additional load on the electrical circuitry which can cause a power variation and result in failure of the anti-lock brake system found on many late model motorcycles.

Thus, there exists a need for vehicle LED lighting systems, integrated and segregated, which are more noticeable and visible to other drivers and incorporate LED sequential lighting.

### SUMMARY

Accordingly, a first embodiment of the present invention is a LED lighting system for a vehicle comprising: a series of light emitting diodes mounted on a circuit board; a housing having a plurality of compartments, each compartment configured to contain one or more of said light emitting diodes; a control circuit operable to illuminate said light emitting diodes in a pre-determined sequence to signify a current state of said vehicle or an intended maneuver of said vehicle.

A method of operating a lighting system integrated in a vehicle comprises: programming a control device to control a lighting device; and linking said control device to said lighting device, said control device programmed to drive a series of light emitting diodes of said lighting device in a pre-determined sequence to indicate a current state of said vehicle or an intended maneuver of said vehicle.

An after market lighting system kit of the present invention comprises: at least one of the following: one or more brake light units; one or more turn signal units; one or more running lights units; and a control circuit having a processor programmed to drive a series of light emitting diodes of said at least one or more brake light units, turn signal units or running lights units in a pre-determined sequence to indicate a current state of said vehicle or an intended maneuver of said vehicle.

The embodiments of the present invention comprise a sequential lighting system that is controlled by a control circuit, as described in detail below. In one example, in response to a vehicle's turn signal lever being engaged, a series of aligned light emitting diodes (“LEDs”) forming part of the exterior turn signal, is sequentially illuminated to indicate that the vehicle intends to make a turn in the direction of the engaged turn signal lever. Such a sequential lighting system provides a more noticeable and visible image than conventional lighting systems which comprise an on-off illumination of one or more LEDs forming the turn signal. In addition, LEDs are bright and use very little electrical power and, thus, have minimal effect on the pre-existing brake or signal light wiring of the subject vehicle.

In an alternative embodiment, the sequential lighting system is pre-programmed to automatically set the flasher rate of a corresponding turn signal to an effective rate. In other words, if the flasher rate is too high, the sequential lighting is not noticeable such that all segments of the sequential lighting system appear to be illuminated simultaneously. To the contrary, if the flasher rate is too low, the flasher takes on a series of illuminated segments which do not work together to notify others of the intention of the vehicle. Such an alternative embodiment comprises an aftermarket turn signal unit formed of a series light emitting diodes mounted on a circuit board; and a control circuit operable to illuminate said light emitting diodes in a pre-determined sequence to signify an intended maneuver of said vehicle, said control circuit programmed to automatically determine a flasher rate associated with said series of light emitting diodes based on a flasher rate associated with a turn signal unit of the vehicle.

Other variations, embodiments and features of the present invention will become evident from the following detailed description, drawings and claims.

### BRIEF DESCRIPTION OF THE DRAWINGS

FIG. 1 illustrates an exemplary configuration of LEDs for a motorcycle turn signal;

FIG. 2 illustrates another exemplary configuration of LEDs for a motorcycle turn signal;

FIG. 3 illustrates an external portion of a motorcycle turn signal housing for containing said LEDs;

FIGS. 4 and 4A illustrate an internal portion of the motorcycle turn signal housing for containing said LEDs;

FIGS. 5 and 5A illustrate an alternative internal portion of the motorcycle turn signal housing for containing said LEDs;

FIG. 6A-6D illustrates sequential operation of the turn signal;

FIG. 7 illustrates an exemplary block diagram of a control system for controlling the LEDs of the present invention;

FIGS. 8A-8E illustrate timing signal charts for controlling the sequential operation of an exemplary lighting device;

FIG. 9 illustrates a segregated motorcycle lighting system including a brake light unit and left and right turn signal units;

FIGS. 9A-9D illustrates the brake light unit of FIG. 9 in operation according to one embodiment of the present invention;

FIGS. 9E-9L illustrates an alternative turn signal operation of the lighting system of FIG. 9 when the brake is not applied; and

FIG. 10 illustrates an exemplary block diagram of a control system with a light sensor for controlling the brightness of the LEDs.

### DETAILED DESCRIPTION

It will be appreciated by those of ordinary skill in the art that the invention can be embodied in other specific forms without departing from the spirit or essential character thereof. The presently disclosed embodiments are therefore considered in all respects to be illustrative and not restrictive.

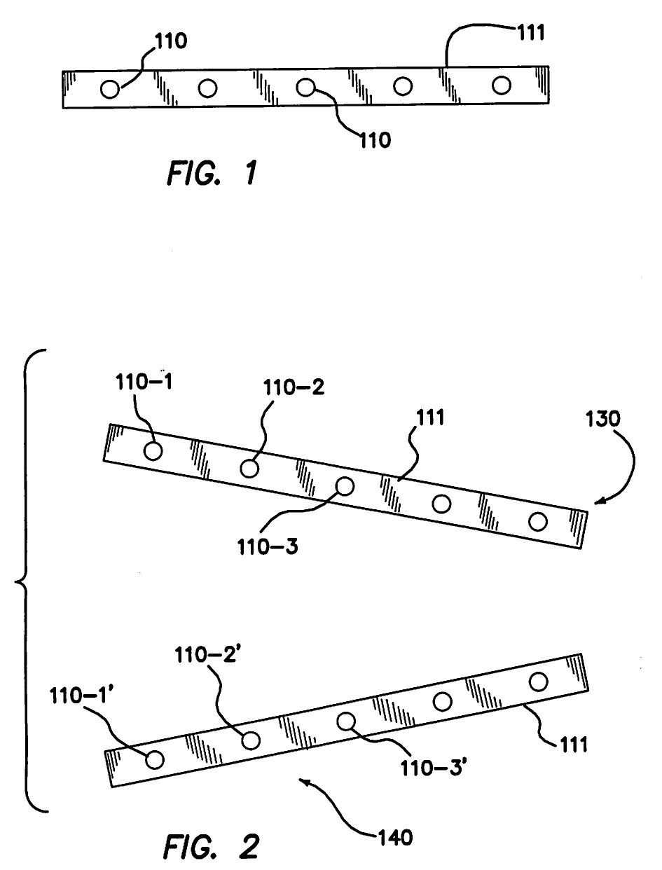

Initial reference is made to FIG. 1 illustrating an exemplary configuration 100 of LEDs 110 in a generally aligned pattern on a circuit board 111 or similar device. The circuit board 111 includes the necessary electrical components (e.g., resistors, leads, etc.) as is well known in the art. The LEDs 110 may be any such devices, but in one embodiment, the LEDs 110 comprise white light emitting diodes (LEDs) and in another they are colored. FIG. 2 illustrates another pattern comprising an upper angled row 120 and lower oppositely angled row 130 of LEDs forming, for example, a right-turn signal 140. As discussed further below, those skilled in the art will recognize that the LEDs may be configured in any other conceivable pattern, including horizontal, vertical or combinations thereof.

Any suitable LED type may be used. Thus, colored LEDs may be incorporated where brake and tail light functions are performed by red LEDs, and the turn signal function is to be performed by red or amber colored LEDs. Alternatively, white LEDs may be used in conjunction with colored lenses. In yet another embodiment, polychromic LEDs may be used, where the particular color emitted is selected by the operating function, that is, when running lights, brake lights, or turn signal light functions are energized by the operator. “Ultra-bright” LEDs may also be used.

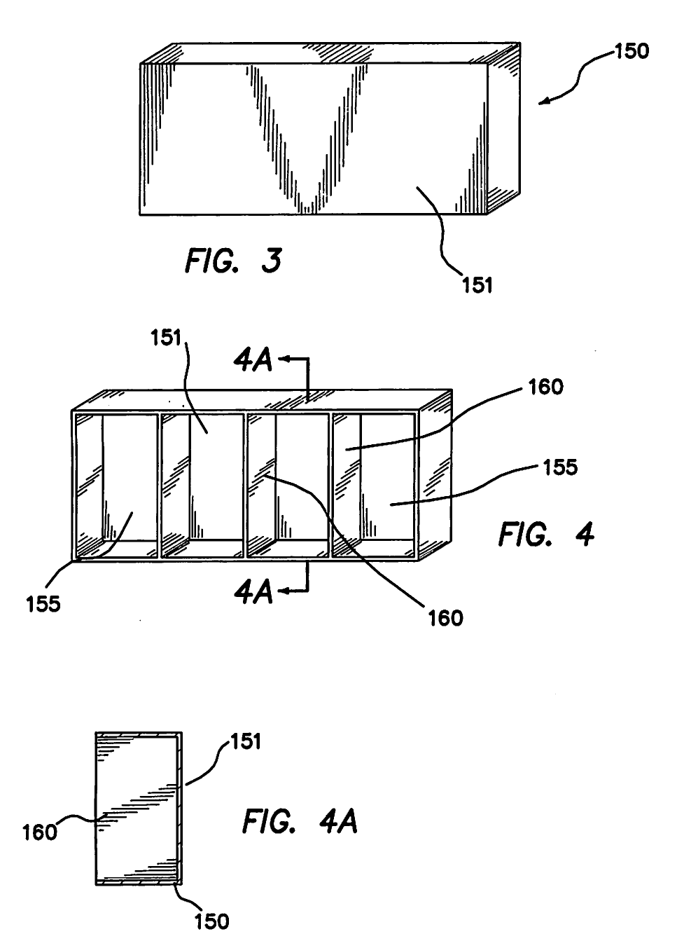

FIG. 3 illustrates an external portion of a turn signal housing 150 are shown. The housing 150 may for rear or front vehicle signals. The housing 150 is fabricated or molded (e.g., injection molded) of a hard plastic or similar material. As shown, the housing 150 is rectangular, but it may be circular, triangular or any other conceivable shape suitable for such a housing 150. The housing 150 defines an internal space for placement of the LEDs 110 and the circuit board 111 to which the LEDs 110 are affixed. To signify a turn signal, the housing plastic is at least partially transparent with at least a front wall 151 yellow in hue such that activation of the white LEDs appear yellow to other motorists. An external and/or internal surface of the front wall 151 may be textured to increase diffusion of the light generated by the white LEDs.

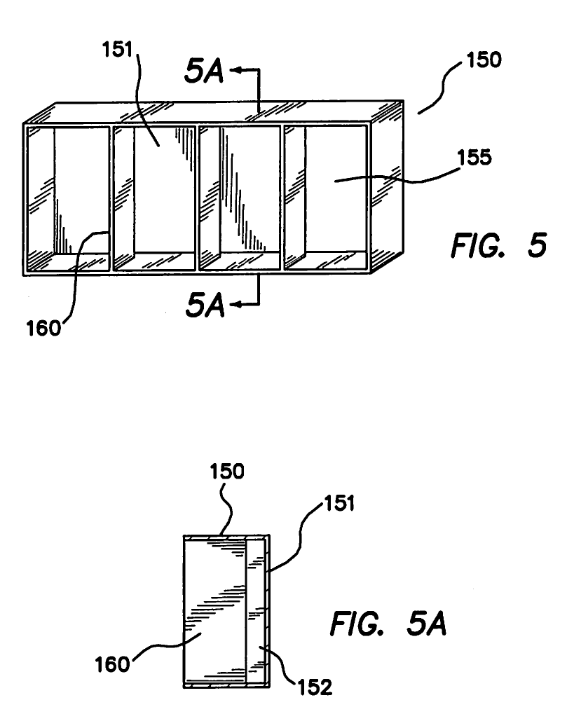

FIGS. 4 and 5 illustrate an internal portion 151 of the housing 150 wherein a series of compartments 155 is formed. The housing 150 is shown with four compartments 155 but it will be apparent to those skilled in the art that fewer or more compartments 155 are conceivable. Walls 160 separate the internal portion of the housing 150 into said compartments 155. In one embodiment, as shown in FIGS. 4 and 4A (cross-sectional view), the walls 160 completely separate the compartments 155 from one another. The walls 160 thus extend to the front wall 151. Alternatively, as shown in FIGS. 5 and 5A (cross-sectional view), the walls 160 may only partially separate the compartments 155 from one another such a space 152 exists between the walls 160 and front wall 151. The space 152 is small so that a large amount of light does not travel from one compartment to another. The walls 160 are substantially opaque to prevent light generated by the LEDs 110 from traveling between compartments 155.

With a conventional motorcycle turn-signal unit, one or more LEDs blink in unison, at a constant rate, to signify that the operator of the motorcycle intends to make a turn. With the embodiments of the present invention, the series of LEDs 110 are illuminated and turned off in sequence to signify that the motorcycle intends to make a turn. Such a sequential operation is more immediately noticeable and visible to other drivers.

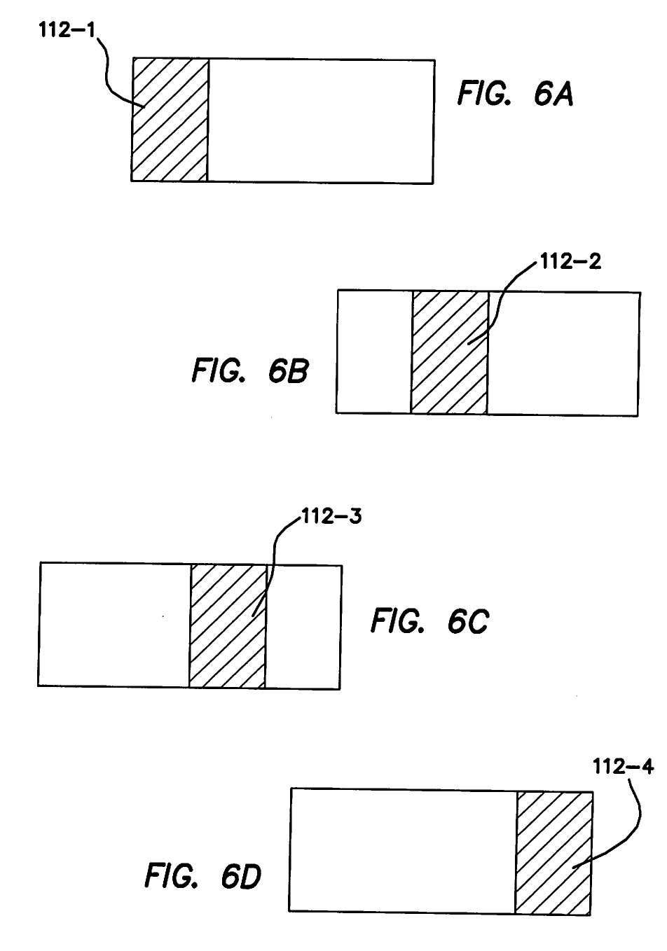

One such sequential operation of the turn signal is shown in FIGS. 6A-6D. Once the turn signal is engaged via a switch on the handlebar grip or other means (e.g., the right handlebar in this example), as shown in FIG. 6A, a first illumination device (e.g., LED) 110-1 is illuminated thereby illuminating a first compartment 112-1 as shown by the hatched markings. At this time, all other LEDs 110-2 through 110-4 remain inactive. A short time period later, as shown in FIG. 6B, illumination device 110-2 is illuminated thereby illuminating a second compartment 112-2 while illumination device 110-1 has been turned off and LEDs 110-3 and 1104 remain inactive. A short period later, as shown in FIG. 6C, illumination device 110-3 is illuminated thereby illuminating a third compartment 112-3 while illumination device 110-2 has been turned off and LEDs 110-1 and 110-4 remain inactive. A short time period later, as shown in FIG. 6D, illumination device 110-4 is illuminated thereby illuminating a fourth compartment 1124 while illumination device 110-3 has been turned off and LEDs 110-1 and 110-2 remain inactive. As shown, the sequencing of the LEDs 110 generates a moving pattern of light to the right thus indicating the motorcycle's intended turn in the right direction.

The turn signal configuration illustrated in FIG. 2 operates in the same manner except that corresponding LEDs (i.e., 110-1, 110-1′; 110-2; 110-2′; 110-3, 110-3′, etc.) in the upper angled row 130 and lower angled row 140 are simultaneously illuminated in sequence to indicate a left or right turn. As set forth above, any pattern of LEDs 110 can be created and utilized with the embodiments of the present invention.

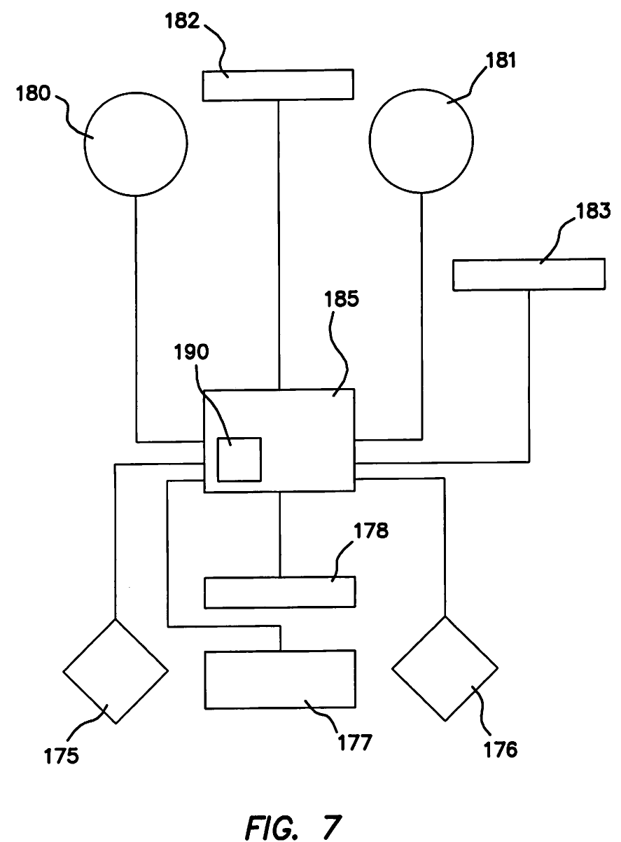

FIG. 7 illustrates a block diagram of a control system 170 for sequentially controlling the LEDs 110. The system 170 comprises multiple lighting devices, including a left turn signal unit 175, right turn signal unit 176, brake light unit 177 and running lights unit 178, lighting device activation means, including a left turn signal lever, knob or switch 180, right turn signal lever 181, hand or foot brake 182 and ignition sensor 183 (or other device for activating running lights) corresponding to each lighting device 175-178, and a control circuit board 185 having a controller, processor 190 or similar device including an integrated or separate timing mechanism for sequentially illuminating a plurality of LEDs included in the lighting devices 175-178. As one of the lighting device activation means 180-183 (e.g., left turn signal knob 180) is engaged, the processor 190 causes each of the LEDs in the lighting device 175-178 to sequentially activate in a pre-determined pattern as described herein. A single processor 190 may be programmed to control multiple configurations of lighting devices 175-178 or each lighting device 175-178 may be controlled by a unique control system 170 and processor 190. It should be understood that programming the processor 190 and configuring the circuit board 185 is well within the level of one skilled in the art.

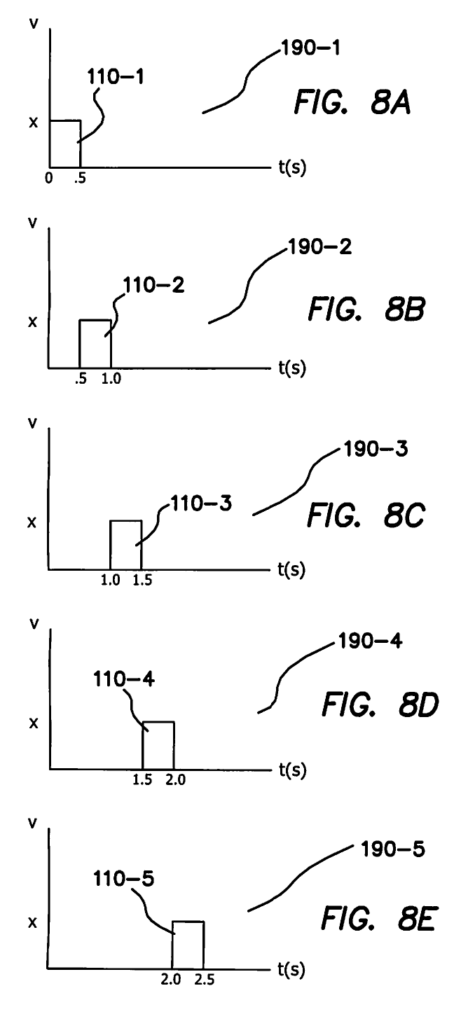

FIGS. 8A-8E illustrate a series of timing charts 190-1 through 190-5 for one configuration of a turn signal according to the embodiments of the present invention. The charts 190-1 through 190-5 map an applied voltage versus illumination time for each illumination device (four in this case) forming part of a turn signal unit. As shown, a sufficient voltage (x) is applied to each illumination device 110-1 through 110-4, in sequence, for 0.5 seconds. Chart 190-5 shows the sequence beginning again with the illumination of illumination device 110-1. The timing of the sequence may be altered as necessary and more or less than four LEDs 110-1 through 110-4 may form a part of the lighting device.

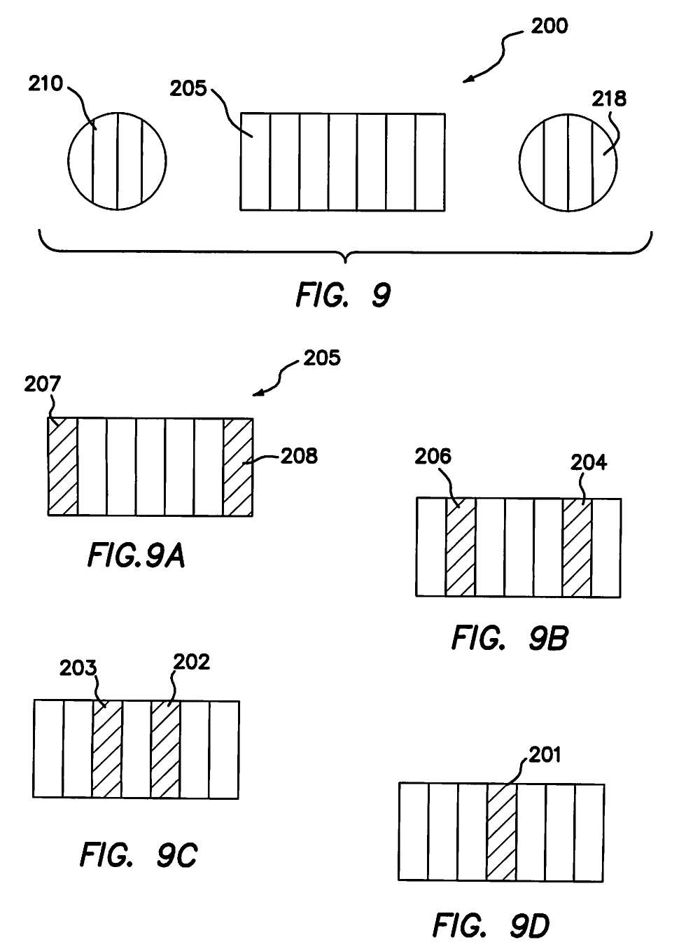

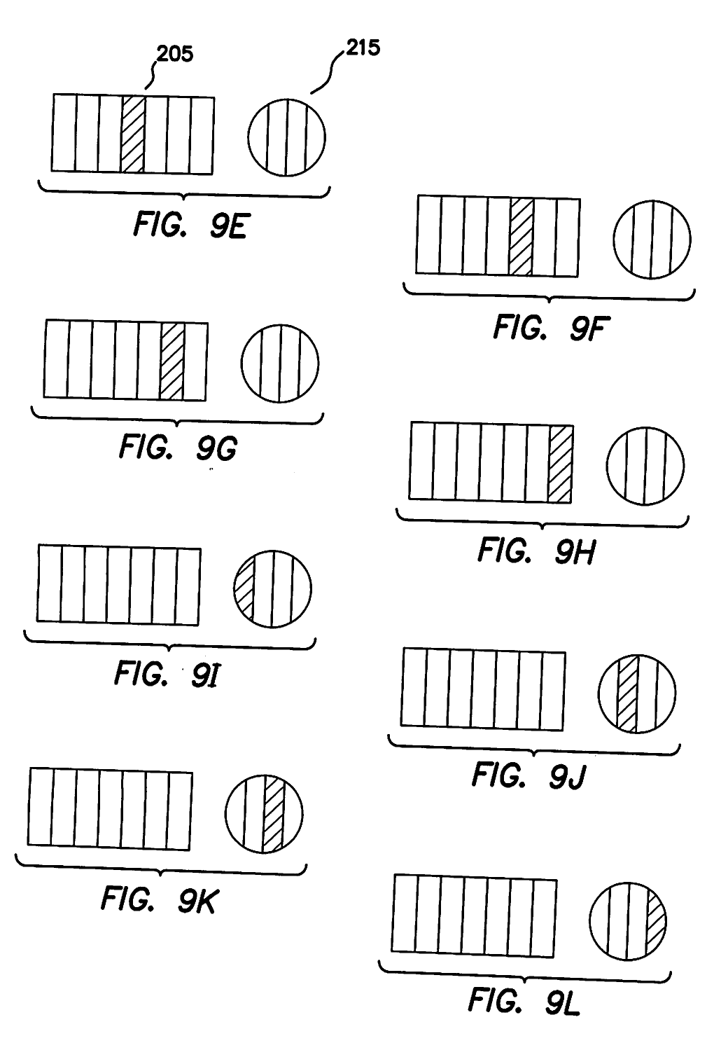

FIG. 9 illustrates a motorcycle lighting system 200 including a brake light unit 205, left turn signal unit 210 and right turn signal unit 215. As described above, the brake light unit 205, left turn signal unit 210 and right turn signal unit 215 each include a housing (i.e., yellow for turn signals and amber for the brake light or the appropriate colored LEDs) defining multiple internal compartments containing one or more LEDs each. In operation, the turn signal units 210, 215 function as described above.

In one embodiment, as shown in FIGS. 9A through 9D, the LEDs of the brake light unit 205 are sequentially illuminated beginning with the one or more LEDs in each outer compartment 206, 207 and then one or more LEDs in each adjacent inner compartment 201-205 are illuminated in sequence as others are turned off or remain off. The effect is two sequential patterns of light moving toward a center of the brake light (i.e., compartment 201). This may be repeated three to five times to signal that the motorcycle (or automobile) is slowing down. Thereafter, the sequential operation is terminated and each of the LEDs in the brake light unit 205 remain illuminated until the brake is disengaged.

In another embodiment, as shown in FIG. 9E-9L, in response to a turn signal interface being engaged by an operator (without brake), the sequential operation begins at a center of the brake light unit 205 in the direction of the engaged turn signal (right as shown in FIGS. 9E-9L). When the sequence of illuminated LEDs reaches an outer compartment of the brake light unit 205, the sequence continues with the right turn signal unit 215. This procedure is repeated as set forth above.

In an emergency situation, the sequential pattern, from outside to inside, runs continuously until the emergency situation is resolved. If a turn signal unit 210, 215 is also activated during a braking procedure, the LEDs in the brake light unit 205 are each illuminated immediately in response to the brake being applied. In other words, there should be only one sequential lighting operation occurring at a single time to avoid confusing other drivers. In one embodiment, the motorcycle may also include a running lights unit (not shown) which operates sequentially while the motorcycle is running. In this embodiment, the LEDs of the running lights unit are illuminated at 30% to 60% of their maximum level (or weaker LEDs are used) to minimize the distraction to other drivers.

The embodiments of the present invention may be manufactured new with automobiles, motorcycles and other street legal vehicles or may be added as an after market product. An after market kit may include the control circuit 185 and lighting devices 175-178, which may include turn signal units, brake light units and/or running lights units for automobiles, motorcycles and other street legal vehicles. The turn signal units, brake light units and running lights units may include a housing and/or LEDs on a circuit board. In an after market embodiment, the control circuit 185 is installed such that one or more control circuit inputs are connected to the vehicle's turn signal, brake light and running lights interface devices (e.g., turn signal lever) while control circuit outputs are connected to the corresponding installed turn signal units, brake light units and/or running lights units.

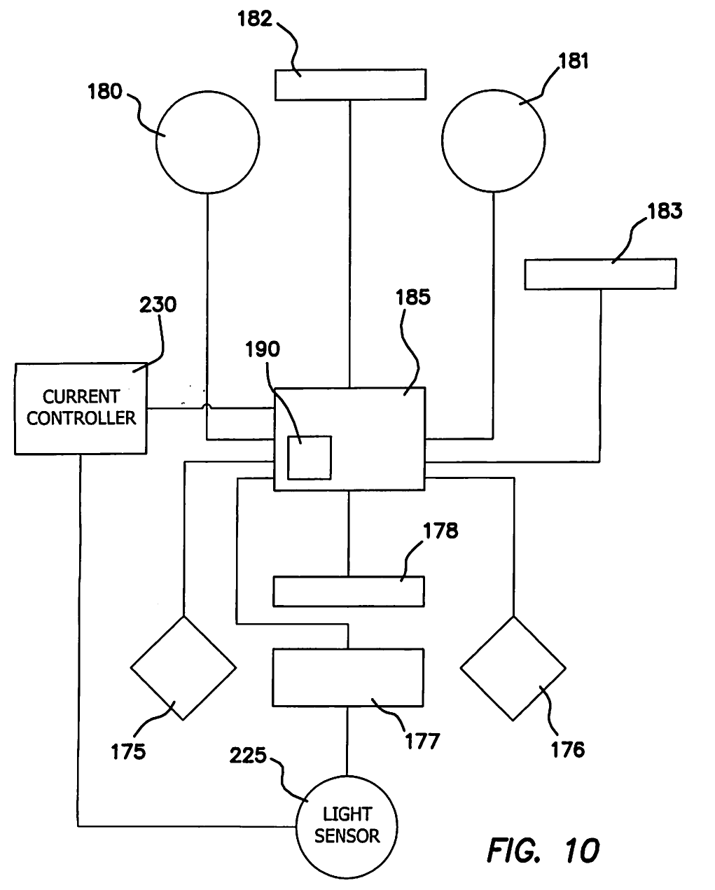

In another embodiment, the brightness of the LEDs is automatically controlled based on the environmental conditions in which the vehicle is traveling. Thus, in areas of high ambient or man-made light (e.g., from other vehicle lighting systems) the LEDs are activated with larger levels of electric current or voltage to render them brighter and in areas of low ambient or man-made light the LEDs are activated using lower current or voltages to make them dimmer. As shown in FIG. 10, a light sensor 225, such as a photodiode, phototransistor, photocell or the like, is integrated in, or adjacent to, the housing 150 in which the LEDs 110 are contained. The light sensor 225 measures the amount of light (ambient and man-made) near the housing 150. The desired range of light measurement can be dictated by the sensor 225. When the measured light amount is above a threshold light value, the LEDs 110, when illuminated, are provided with high current levels to render the LEDs 110 brighter and therefore more visible relative to the surrounding light. Alternatively, when the measured light amount is below a threshold light value, the LEDs 110, are provided with lower current levels to render the LEDs 110 dimmer relative to the surrounding light so that they do not interfere with other motorists. The current level is controlled by current controller 230 integrated into the control circuit 185. The current controller 230 may also be a separate device. The light value may be measured at a pre-determined frequency (e.g., 2 seconds). In one embodiment, the electric current level sent to the LEDs 110 is dependent on the most recent measured light value immediately prior to the vehicle operator engaging one of the vehicle's lighting device activation means. Alternatively, the sensor 225 may be polled in response to the operator engaging one of the vehicle's lighting device activation means. Then, in response to the polling, a corresponding current is sent to the LEDs.

In an alternative embodiment for controlling the brightness of the LEDs, multiple sets of LEDs, having varying strengths, are used to from lighting devices. Depending, on the measured amount of light, current is sent to the corresponding set of the LEDs having the desired strength and therefore brightness level.

The use of the light sensor 225 can be used on non-sequential lighting systems as well. That is, conventional lighting systems may benefit from the ability to control the brightness of the LEDs (or other lighting means) in response to the ambient or man-made light surrounding the vehicle.

The embodiments of the present invention may be used with any types of vehicle lighting system including integrated lighting systems where the brake lights, turn signal lights and running lights are incorporated into a single or multiple units or devices. Moreover, the embodiments of the present invention may be used with front lights, side lights and any other configuration of vehicle lighting systems on any type of vehicle.

In another embodiment, a flasher rate corresponding to sequential turn signals is automatically set by the programming associated with circuit board 111. That is, the flasher rate of the standard turn signal hardware is such that it may be too fast or slow to translate to an effective sequential turn signal rate. The processor of the circuit board 111 is thus programmed to determine the flasher rate of the turn signal hardware and adjust the flasher rate accordingly to produce an effective flasher rate for the sequential turn signal. In other words, if the flasher rate is too high, the sequential lighting is not noticeable such that all segments of the sequential lighting system appear to be illuminated simultaneously. To the contrary, if the flasher rate is too low, the flasher takes on a series of independent illuminated segments which do not work together to notify others of the intention of the vehicle.

The circuit board 111 is also programmed to automatically adjust responsive to the flashers being changed. In this manner, the single circuit board 111 accommodates any and all sequential flashers which are installed. Additionally, the flasher rate is stored in memory associated with the circuit board 111 such that any power loss to the system does not erase the stored flasher rate.

Although the invention has been described in detail with reference to several embodiments, additional variations and modifications exist within the scope and spirit of the invention as described and defined in the following claims.

I claim:

1. A lighting system for a vehicle comprising:
an aftermarket turn signal unit formed of a series light emitting diodes mounted on a circuit board; and
a control circuit operable to illuminate said light emitting diodes in a pre-determined sequence to signify an intended maneuver of said vehicle, said control circuit programmed to automatically determine a flasher rate associated with said series of light emitting diodes based on a flasher rate associated with a turn signal unit of the vehicle.

2. The lighting system of claim 1, wherein a control circuit input is connected to a turn signal control output.

3. The lighting system of claim 1, wherein the control circuit is integrated into an electrical system of said vehicle.

4. The lighting system of claim 1, wherein the control circuit stores a determined flasher rate.

5. The lighting system of claim 1, wherein the control circuit automatically determines a flasher rate responsive to said aftermarket turn signal being installed.

6. A lighting system for a vehicle comprising:
a plurality of light emitting diodes;
a housing defining a plurality of compartments, said compartments adapted to contain one or more of said light emitting diodes; and
control means operable to illuminate said light emitting diodes in a pre-determined sequence to signify an intended maneuver of said vehicle, said control means programmed to automatically determine a flasher rate associated with said series of light emitting diodes based on a flasher rate associated with a turn signal unit of the vehicle.

7. The lighting system of claim 6, further comprising a control circuit input is connected to a turn signal control output.

8. The lighting system of claim 6, wherein the control circuit is integrated into an electrical system of said vehicle.

9. The lighting system of claim 6, wherein the control circuit stores a determined flasher rate.

10. The lighting system of claim 6, wherein the control circuit automatically determines a flasher rate responsive to said aftermarket turn signal being installed.

11. The lighting system of claim 6, wherein a control means input is connected to a turn signal control output.

12. The lighting system of claim 6, wherein the control means is integrated into an electrical system of said vehicle.

13. An after market lighting system kit comprising:
one or more turn signal units having a series of light emitting diodes; and
a control circuit having a processor programmed to drive said series of light emitting diodes of said at least one or more turn signal units in a pre-determined sequence to indicate an intended maneuver of said vehicle, said processor further programmed to automatically determine a flasher rate associated with said series of light emitting diodes based on a flasher rate associated with a turn signal unit of the vehicle.

14. The after market lighting system kit of claim 13, wherein said control circuit has an input configured to connect to a signal control output.

15. The after market lighting system kit of claim 13, wherein the control circuit is configured to integrate into an electrical system of said vehicle.

16. The after market lighting system of claim 13, wherein the control circuit is configured to store a determined flasher rate.

17. The after market lighting system of claim 13, wherein the control circuit automatically determines a flasher rate responsive to said aftermarket turn signal being installed.
